(19) United States
(12) Patent Application Publication
(10) Pub. No.: US 2026/0058482 A1
(43) Pub. Date: Feb. 26, 2026

(54) SYSTEM AND METHOD FOR CONTROLLING CHARGING AND DISCHARGING OF BATTERY

(71) Applicant: Samsung SDI Co., Ltd., Yongin-si (KR)

(72) Inventors: HYEONWOO KIM, Yongin-si (KR); YUBIN HWANG, Yongin-si (KR)

(73) Assignee: Samsung SDI Co., Ltd., Yongin-si (KR)

(21) Appl. No.: 19/019,095

(22) Filed: Jan. 13, 2025

(30) Foreign Application Priority Data
Aug. 22, 2024 (KR) 10-2024-0112566

(51) Int. Cl. H02J 7/00

(52) U.S. Cl. CPC H02J 7/0024; H02J 7/0032; H02J 7/00711

(57) ABSTRACT

A system and method are provided for controlling charging and discharging of a group of batteries connected in parallel. A battery charging/discharging control system includes a first battery group comprising one or more first batteries connected in parallel, a second battery group connected in parallel with the first battery group and comprising one or more second batteries connected in parallel, and a charging/discharging controller to generate a first current pulse and a second current pulse, different from the first current pulse. The charging/discharging controller supplies the first current pulse and the second current pulse to the first battery group and the second battery group to control charging/discharging.

### CROSS-REFERENCE TO RELATED APPLICATIONS

This present application claims priority to and the benefit under 35 U.S.C. § 119(a)-(d) of Korean Patent Application No. 10-2024-0112566, filed on Aug. 22, 2024, in the Korean Intellectual Property Office, the entire disclosure of which is incorporated herein by reference.

### FIELD

The present disclosure relates to a system and method for controlling charging and discharging of a group of batteries connected in parallel.

### BACKGROUND

In modern society, many electronic devices are used, with mobility and portability being important. Accordingly, the importance of battery charging technology is increasing. In particular, efficient and rapid battery charging is required, but existing rapid charging methods have a negative influence on battery life and have limitations in charging several batteries at the same time.

The above-described information disclosed in the technology section that serves as the background of the present disclosure is only for improving the understanding of the background of the present disclosure, and thus may include information that does not constitute related art.

### SUMMARY

The present disclosure provides a battery charging/discharging control system and method in which by using a reverse current generated while pulse-charging any one battery group, a current may be supplied to another battery group, thereby simultaneously charging several batteries.

However, technical problems to be solved by the present disclosure are not limited to the above-mentioned problem, and other problems not mentioned may be clearly understood by those of ordinary skill in the art from the description of the present disclosure described below.

Additional aspects will be set forth in part in the description which follows and, in part, will be apparent from the description, or may be learned by practice of the presented embodiments of the present disclosure.

According to some embodiments, a battery charging/discharging control system includes a first battery group including one or more first batteries connected in parallel, a second battery group connected in parallel with the first battery group and including one or more second batteries connected in parallel, and a charging/discharging controller to generate a first current pulse and a second current pulse different from the first current pulse and to supply the first current pulse and the second current pulse to the first battery group and the second battery group to control charging/discharging.

According to some embodiments, a battery charging/discharging control method performed by a processor of a charging/discharging controller to control charging/discharging of a first battery group including one or more first batteries connected in parallel and a second battery group including one or more second batteries connected in parallel with the first battery group includes generating a first current pulse and a second current pulse different from the first current pulse and controlling charging/discharging by supplying the first current pulse and the second current pulse to the first battery group and the second battery group.

According to some embodiments, a method and a system for implementing aspects of the present disclosure, and a non-transitory computer-readable recording medium having stored therein a computer program for executing the battery charging/discharging control method may be further provided.

Other aspects, features, advantages, and advantages other than those described above will become apparent from the following figures, claims, and the detailed description of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

The following drawings attached to this specification illustrate embodiments of the present disclosure, and serve to further describe the present disclosure together with the detailed description of the present disclosure described later. Thus, the present disclosure should not be construed as being limited to the matters shown in such drawings.

FIG. 1 illustrates an exemplary configuration of a battery charging/discharging control system according to some embodiments;

FIGS. 2A and 2B illustrate configurations of a charging/discharging closed loop formed from a battery charging/discharging control system according to some embodiments;

FIG. 3 illustrates an exemplary configuration of a charging/discharging controller of a battery charging/discharging control system according to some embodiments;

FIG. 4 illustrates an exemplary configuration of a charging/discharging controller of a battery charging/discharging control system according to some embodiments;

FIG. 5 is a flowchart of a battery charging/discharging control method according to some embodiments;

FIGS. 6A and 6B illustrate an exemplary configuration of a battery charging/discharging control system according to some embodiments;

FIGS. 7A and 7B illustrate an exemplary configuration of a battery charging/discharging control system according some embodiments;

FIGS. 8A through 8D are pulse timing diagrams used in a battery charging/discharging control system according to some embodiments;

FIGS. 9A and 9B illustrate exemplary configurations of a battery charging/discharging control system according to some embodiments;

FIGS. 10A and 10B illustrate exemplary configurations of a battery charging/discharging control system according to some embodiments; and

FIG. 11A through 11D are pulse timing diagrams used in a battery charging/discharging control system according to some embodiments.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

Hereinafter, embodiments of the present disclosure will be described in detail with reference to the accompanying drawings. The terms and words used in the present specification and claims described above should not be construed as being limited to ordinary or dictionary meanings, and should be interpreted as meanings and concepts consistent with the technical idea of the present disclosure based on the principle that the present inventors may appropriately define the concept of the terms to describe their invention in the best way. Therefore, it should be understood that the exemplary configurations shown in the drawings and exemplary embodiments described in this specification are merely explanatory, and do not represent all of the technical ideas of the present disclosure, such that there may be various equivalents and variations that replace aspects of them at the time of filing the present application. If used herein, “comprise, include” and/or “comprising, including” specify mentioned shapes, numbers, steps, operations, members, components, and/or presence of these groups, and do not exclude the presence or addition of one or more different shapes, numbers, operations, members, components, and/or groups. If embodiments of the present disclosure are described, “can” or “may” may include “one or more embodiments of the present disclosure”.

To help understanding of the present disclosure, the accompanying drawings are not shown according to the actual scale, but the dimensions of some components may be exaggerated. The same reference numeral may be given to the same component in different embodiments.

The statement that two comparison targets are “the same” as each other may mean that they are “substantially the same” as each other. Thus, a case where they are ‘substantially the same’ as each other may include a case where they have a deviation regarded as a low level, e.g., a deviation of 5% or less. If a uniform parameter is uniform in a predetermined area, it may mean that it is uniform from an average point of view.

Although first, second, etc., may be used to describe various components, these components are not limited by these terms. These terms are only used to distinguish one component from other components, and unless specifically stated to the contrary, a first component may be a second component.

Throughout the specification, unless specially stated to the contrary, each component may be singular or plural.

If a component is arranged on “a top portion (or a bottom portion)” of another component or “on (or under)” the other component, it may mean not only a case where the component is arranged adjacent to a top surface (or a bottom surface) of the other component, but also a case where another component may be interposed between the other component and the component arranged on (or under) the other component.

If a component is described as being “connected”, “coupled”, or “connected” to another component, it should be understood that the components are directly connected or connectable to each other, but another component may be “interposed” between the components, or the components may be “connected”, “coupled”, or “connected” to each other through another component. If a portion is electrically coupled to another portion, this may include not only a case where they are directly connected to each other, but also a case where they are connected with another element therebetween.

Throughout the specification, “A and/or B” may mean A, B, or A and B unless specially stated otherwise. That is, “and/or” may include all or any combination of a plurality of items listed. “C to D” may mean at least C and not more than D, unless specially stated otherwise.

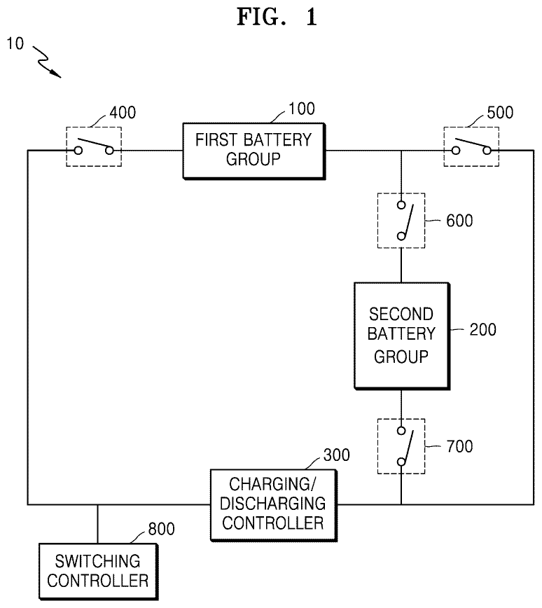

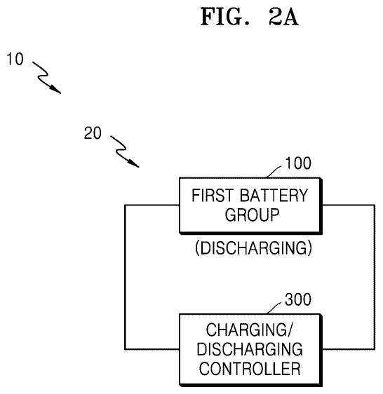

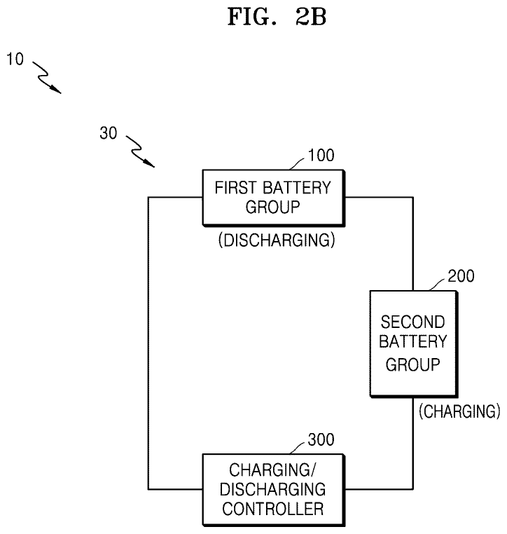

FIG. 1 illustrates an exemplary configuration of a battery charging/discharging control system 10 according to some embodiments. FIGS. 2A and 2B illustrate exemplary configurations of a charging/discharging closed loop formed from a battery charging/discharging control system 10 according to some embodiments. The exemplary battery charging/discharging control system 10 of FIG. 1 includes a first battery group 100, a second battery group 200, a charging/discharging controller 300, a first switching unit 400, a second switching unit 500, a third switching unit 600, a fourth switching unit 700, and a switching controller 800.

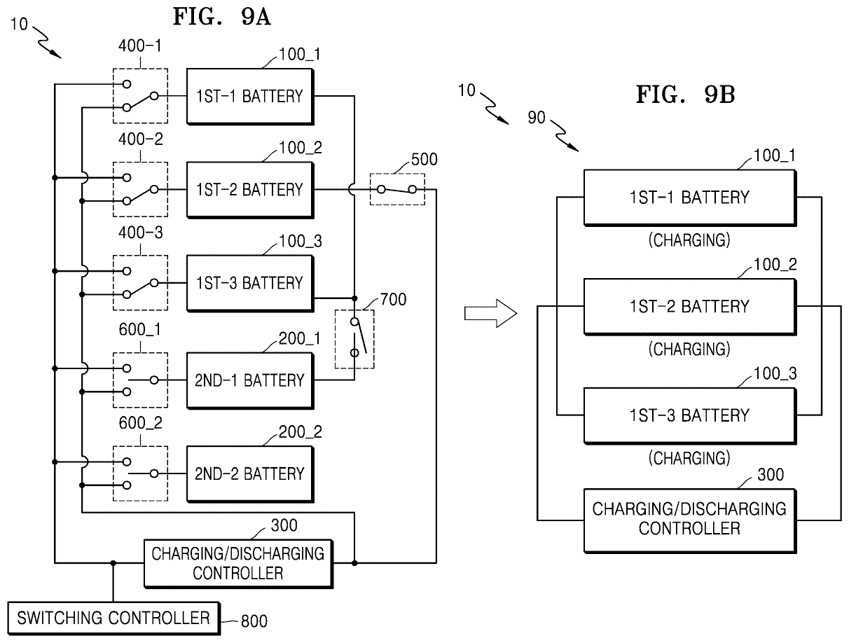

The first battery group 100 may include one or more first batteries 100_1, 100_2, . . . , 100_N such as shown in FIG. 9A with N=3. The one or more first batteries 100_1, 100_2, . . . , 100_N may be connected in parallel within the first battery group 100.

The second battery group 200 may be connected in parallel with the first battery group 100 and may include one or more second batteries 200_1, 200_2, . . . , 200_N such as shown in FIG. 9A N=2. The one or more second batteries 200_1, 200_2, . . . , 200_N may be connected in parallel within the second battery group 200.

The one or more first batteries 100_1, 100_2, . . . , 100_N and the one or more second batteries 200_1, 200_2, . . . , 200_N may store power and include at least one battery cell (not shown). The one or more first batteries 100_1, 100_2, . . . , 100_N and the one or more second batteries 200_1, 200_2, . . . , 200_N may include one battery cell. The one or more first batteries 100_1, 100_2, . . . , 100_N and the one or more second batteries 200_1, 200_2, . . . , 200_N may include a plurality of battery cells. Battery cells may be connected in series, in parallel, or in combination thereof. The number and connection method of battery cells included in the one or more first batteries 100_1, 100_2, . . . , 100_N and the one or more second batteries 200_1, 200_2, . . . ,200_N may be determined according to a required power storage capacity.

The battery cells of secondary batteries may not only result in rechargeable lead-acid batteries. For example, the battery cells of secondary batteries may result in a nickel-cadmium battery, a nickel metal hydride battery (NiMH), a lithium ion battery, a lithium polymer battery, etc.

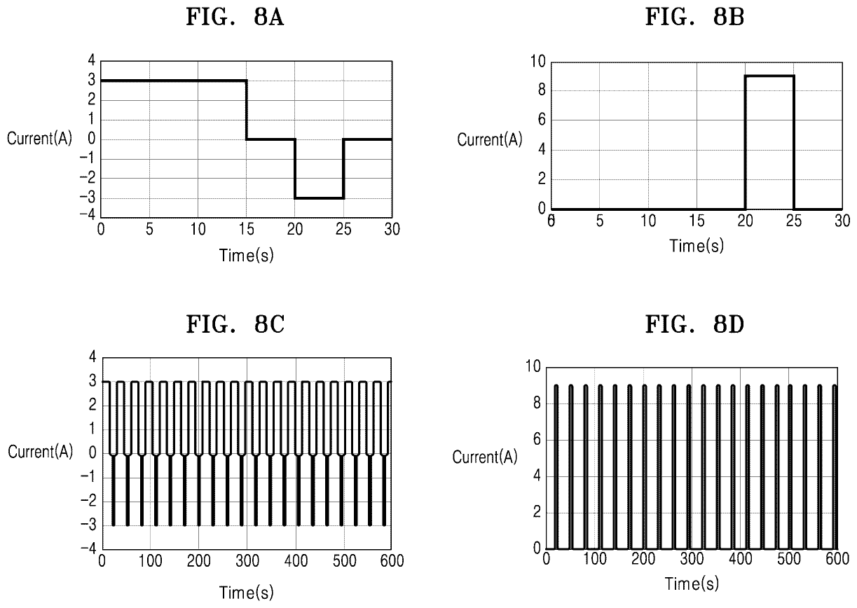

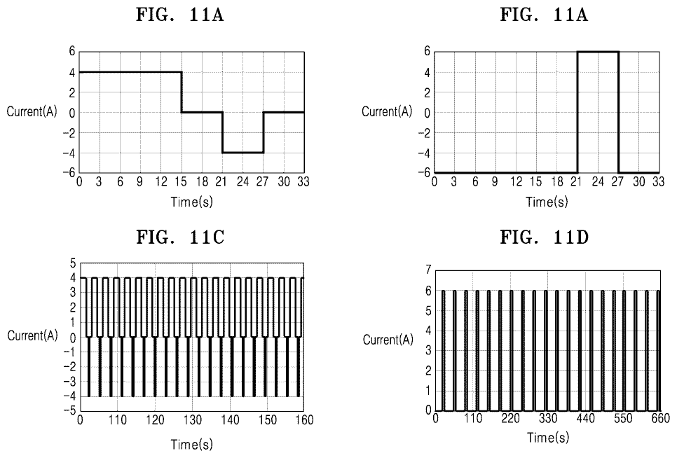

The charging/discharging controller 300 may generate a first pulse and generate a second pulse different from the first pulse. The first pulse and the second pulse may be current pulses, as further discussed with reference to FIGS. 8A-8D and FIGS. 11A-11D. The charging/discharging controller 300 may supply the first pulse and the second pulse to the first battery group 100 and the second battery group 200, and may control charging/discharging of the first battery group 100 and the second battery group 200. The charging/discharging controller 300 may control the charging/discharging of the first battery group 100 by supplying the first pulse to the first battery group 100. The charging/discharging controller 300 may control the charging of the second battery group 200 by supplying the second pulse to the second battery group 200.

The charging/discharging controller 300 may control the second battery group 200 to enter a deactivated state during the charging of the first battery group 100. The charging/discharging controller 300 may control the second battery group 200 to be charged during the discharging of the first battery group 100.

According to some embodiments, the battery charging/discharging control system 10 may further include a plurality of switching units, such as the first switching unit 400 through the fourth switching unit 700 shown for the exemplary battery charging/discharging control system 10 in FIG. 1, and the switching controller 800 that controls switching on/off of the plurality of switching units.

The first switching unit 400 to the fourth switching unit 700 may be turned on and off such that the first battery group 100 and the charging/discharging controller 300 form a first closed loop 20 (FIG. 2A). In addition, the first switching unit 400 to the fourth switching unit 700 may be turned on and off such that the first battery group 100, the second battery group 200, and the charging/discharging controller 300 form a second closed loop 30 (FIG. 2B).

The first switching unit 400 may be configured such that a first end thereof is connected to a first end of the charging/discharging controller 300 and a second end thereof is connected to the first end of the first battery group 100. The second switching unit 500 may be configured such that a first end thereof is connected to the second end of the first battery group 100 and a second end thereof is connected to a second end of the charging/discharging controller 300. The third switching unit 600 may be configured such that a first end thereof is connected to the second end of the first battery group 100 and a second end thereof is connected to the first end of the second battery group 200. The fourth switching unit 700 may be configured such that a first end thereof is connected to the second end of the second battery group 200 and a second end thereof is connected to the second end of the charging/discharging controller 300.

According to some embodiments, the first switching unit 400 to the fourth switching unit 700 may be components for forming the first closed loop 20 or the second closed loop 30. The first switching unit 400 to the fourth switching unit 700 shown in FIG. 1 are examples including two ends. However, the first switching unit 400 to the fourth switching unit 700 may have flexible configurations thereof and may include two ends, three ends, or more ends depending on requirements. These various end configurations may be optimized according to the circuit design of the battery charging/discharging control system 10. The design of each of the first switching unit 400 to the fourth switching unit 700 may be customized to meet the electrical requirements of the battery charging/discharging control system 10.

The switching controller 800 may control switching on or off of the first switching unit 400 to the fourth switching unit 700 such that the first closed loop 20 is formed during charging of the first battery group 100 by a first pulse (FIG. 8A). The switching controller 800 may generate and output a first switching control signal and a second switching control signal under control of the charging/discharging controller 300.

Specifically, the switching controller 800 may control the first closed loop 20 to be formed, by outputting a first switching control signal for switching on the first switching unit 400 and the second switching unit 500 and switching off the third switching unit 600 and the fourth switching unit 700 during charging of the first battery group 100.

FIG. 2A shows an example in which the first battery group 100 and the charging/discharging controller 300 form the first closed loop 20 by the first switching control signal. As the battery charging/discharging control system forms the first closed loop 20, the first battery group 100 may be charged and the second battery group 200 may enter a deactivated state. In an embodiment, the switching controller 800 may output the first switching control signal during a first time period included in a duration of a cycle of the first pulse.

The switching controller 800 may control the switching on or off of the first switching unit 400 to the fourth switching unit 700 such that the second closed loop 30 is formed during discharging of the first battery group 100 by the first pulse.

Specifically, the switching controller 800 may control the second closed loop 30 to be formed, by outputting a second switching control signal for switching on the first switching unit 400, third switching unit 600, and the fourth switching unit 700 and switching off the second switching unit 500 during discharging of the first battery group 100.

FIG. 2B illustrates an example in which the first battery group 100, the second battery group 200, and the charging/discharging controller 300 form the second closed loop 30 by the second switching control signal. As the battery charging/discharging control system 10 forms the second closed loop 30, the first battery group 100 may be discharged and the second battery group 200 may be charged. According to some embodiments, the switching controller 800 may output the second switching control signal during a third time period included in the first pulse.

According to some embodiments, the switching controller 800 may be included in the charging/discharging controller 300. In other words, a switching-on/off control function of the switching controller 800 may be performed by the charging/discharging controller 300. Meanwhile, the charging/discharging controller 300 may control charging/discharging by generating the first pulse and the second pulse, supplying the first pulse to the first battery group 100, and supplying the second pulse to the second battery group 200.

Generally, battery cells may be rapidly charged using high-rate current. When battery cells are charged using high-rate current, state of charge (SOC) imbalance within the battery cells may be aggravated during a charging process. SOC imbalance within a battery cell may also affect shortening of the life of the battery. The inventors have recognized pulse charging as a way to address this problem. Pulse charging may help resolve SOC imbalance within battery cells by applying resetting between consecutive high-rate charging during the charging process. In addition, the process of applying resetting may include discharging the battery cells in reverse according to some embodiments. In this case, the SOC imbalance within the battery cells may be resolved in a shorter period of time than when the resetting is simply applied.

According to an exemplary embodiment, in one cycle of a first pulse (e.g., FIGS. 8A through 8D and 11A through 11D) supplied to the first battery group 100, a first current is set during a first time period, a second current, less than the first current, is set during a second time period, shorter than the first time period, a third current as a reverse current corresponding to the first current is set during a third time period identical to the second time period, and a fourth current as a current identical to the second current is set during a fourth time period identical to the second time period.

The first battery group 100 may be charged by the first current for the first time period included in one cycle of the first pulse, may be reset by the second current for the second time period, may be discharged by the third current for the third time period, and may be reset by the fourth current for the fourth time period.

One cycle of a second pulse (e.g., FIGS. 8A through 8D and 11A through 11D) supplied to the second battery group 200 may be configured such that a fifth current is set for the first time period and the second time period, a sixth current may be set for the third time period, and a seventh current may be set to be the same as the fifth current for the fourth time period.

The second battery group 200 may be in the deactivated state during the first time period, the second time period, and the fourth time period included in one cycle of the second pulse. The second battery group 200 may be charged by the sixth current during the third time period included in one cycle of the second pulse.

According to some embodiments, the sixth current supplied to the second battery group 200 may be adjusted differently depending on the number of first batteries 100_1, 100_2, . . . , 100_N included in the first battery group 100 and the number of second batteries 200_1, 200_2, . . . , 200_N included in the second battery group 200.

For example, when there is one first battery 100_1 included in the first battery group 100 and one second battery 200_1 included in the second battery group 200, the sixth current may be 3 A. In another example, when there are three first batteries 100_1 to 100_3 included in the first battery group 100 and one second battery 200_1 included in the second battery group 200, the sixth current may be 9 A. In another example, when there are three first batteries 100_1 to 100_3 included in the first battery group 100 and two second batteries 200_1, 200_2 included in the second battery group 200, the sixth current may be 4.5 A.

A formula for calculating the sixth current using this feature may be:

$$Equation 1$$

$$Sixth Current = \frac{\begin{matrix}First Current \times \\ Number of First Batteris included in First Battery Group 100\end{matrix}}{\begin{matrix}Number of Second Batteries included in \\ Second Battery Group 200\end{matrix}}$$

As such, as the first battery group 100 and the second battery group 200 are charged at the same time by supplying current to the second battery group 200 using reverse current generated while pulse-charging the first battery group 100, charging efficiency may be maximized. Moreover, through this configuration, it may be possible to minimize charge imbalance between batteries, efficiently manage power consumption, and shorten a total charging time.

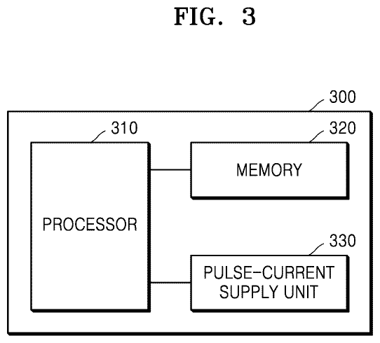

FIG. 3 illustrates an exemplary configuration of a charging/discharging controller 300 of a battery charging/discharging control system 10 according to some embodiments. In the following description, parts redundant to the descriptions of FIGS. 1, 2A and 2B are omitted. Referring to FIG. 3, the exemplary charging/discharging controller 300 may include a processor 310, a memory 320, and a pulse-current supply unit 330.

The processor 310 may control an operation of the battery charging/discharging control system 10. Herein, the ‘processor’ may mean, for example, a data processing device embedded in hardware, which has a physically structured circuit to perform a function represented as a code or a command included in a program. Examples of a data processing device built in hardware may include processing devices such as a microprocessor, a central processing unit, a processor core, a multiprocessor, an ASIC, an FPGA, etc., but the scope of the present disclosure is not limited thereto. The memory (320) may be a non-transitory medium operably connected to the processor 310 and may store at least one code associated with an operation performed by the processor 310.

The memory 320 may perform a function to temporarily or permanently store data processed by the processor 310. Herein, the memory 320 may include a magnetic storage medium or a flash storage medium, but the scope of the present disclosure is not limited thereto. The memory 320 may include internal memory and/or external memory, and may include volatile memory such as DRAM, SRAM, or SDRAM, nonvolatile memory such as OTPROM, PROM, EPROM, EEPROM, mask ROM, flash ROM, NAND flash memory, NOR flash memory, etc., flash drives such as SSD, CF card, SD card, Micro-SD card, Mini-SD card, xD card, a memory stick, etc., or storage devices such as HDD.

According to some embodiments, the memory 320 may store a pattern of a first pulse in which the current is set based on time and a pattern of a second pulse in which the current is set differently from the pattern of the first pulse. According to some embodiments, a pattern of a pulse may define time period and the amount of current. According to some embodiments, the pattern of the first pulse and the pattern of the second pulse may vary depending on the electrical requirements of the battery charging/discharging control system 10.

The pulse-current supply unit 330 may load preset patterns of the first pulse and the second pulse from the memory 320 under the control of the processor 310. The pulse-current supply unit 330 may generate the first pulse and the second pulse based on power received from the power supply unit (not shown) under the control of the processor 310 and the preset patterns of the first pulse and the second pulse stored in the memory 320. According to some embodiments, when the first pulse and the second pulse are generated, the amount of current supplied according to the pattern of the first pulse and the pattern of the second pulse may be changed. The pulse-current supply unit 330 may supply the first pulse and the second pulse to the first battery group 100 and the second battery group 200. Specifically, the pulse-current supply unit 330 may supply the first pulse to the first battery group 100 and the second pulse to the second battery group 200. Meanwhile, the charging/discharging controller 300 may further include a communication unit (not shown) to perform communication with an external device.

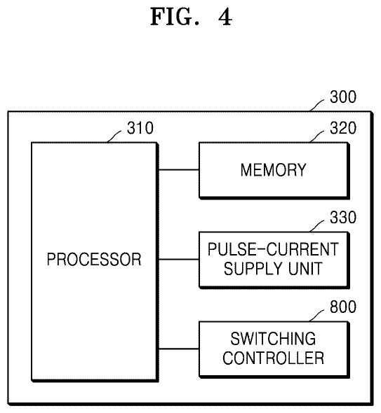

FIG. 4 illustrates an exemplary configuration of a charging/discharging controller 300 of a battery charging/discharging control system 10 according to some embodiments. In the following description, parts redundant to the descriptions of FIGS. 1 to 3 are omitted. Referring to FIG. 3, the exemplary charging/discharging controller 300 may include the processor 310, the memory 320, the pulse-current supply unit 330, and a switching controller 800.

The operations of the processor 310, the memory 320, and the pulse-current supply unit 330 may be the same as in FIG. 3, and, thus, a detailed description is omitted. Compared to FIG. 3, the charging/discharging controller 300 shown in FIG. 4 may further include the switching controller 800. A description of the switching controller 800 has been provided with reference to FIG. 1 and a detailed description is omitted.

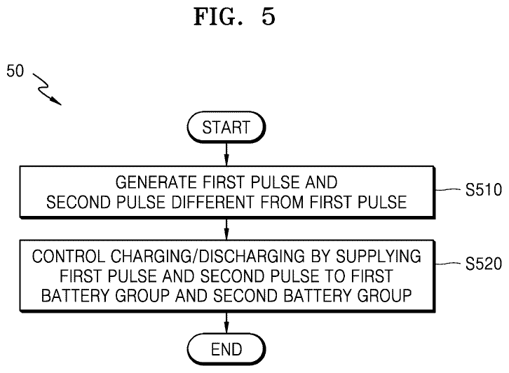

FIG. 5 is a flowchart of a battery charging/discharging control method 50 according to some embodiments. In the following description, parts redundant to the descriptions of FIGS. 1 to 4 are omitted. The battery charging/discharging control method 50 may be performed by the processor 310 of the charging/discharging controller 300 with the help of peripheral components.

Referring to FIG. 5, in operation S510, the processor 310 may generate the first pulse and the second pulse, different from the first pulse.

In operation S520, the processor 310 may control charging and discharging by supplying the first pulse and the second pulse to the first battery group 100 and the second battery group 200.

According to some embodiments, the processor 310 may control charging and discharging of the first battery group 100 by supplying the first pulse to the first battery group 100, and may control charging of the second battery group 200 by supplying the second pulse to the second battery group 200.

According to some embodiments, the processor 310 may control the second battery group 200 to enter the deactivated state during the charging of the first battery group 100.

In an embodiment, the processor 310 may control the second battery group 200 to be charged during the discharging of the first battery group 100.

According to an exemplary embodiment, the processor 310 may generate one cycle of the first pulse in which the first current is set during the first time period, the second current, less than the first current, is set during the second time period, shorter than the duration of the first time period, the third current is set as a reverse current corresponding to the first current during the third time period identical to the duration of the second time period, and the fourth current is set as a current identical to the second current during the fourth time period identical to the duration of the second time. In addition, the processor 310 may generate one cycle of the second pulse in which the fifth current is set during the first time period and the second time period, the sixth current is set during the third time period, and the seventh current is set as a current identical to the fifth current during the fourth time period.

According to some embodiments, the processor 310 may control the first battery group 100 to be charged by the first current and the first battery group 100 to be discharged by the third current, wherein the first current and the third current are included in the first pulse. The processor 310 may control the second battery group 200 to be charged by the sixth current included in the second pulse. According to some embodiments, the sixth current may be adjusted according to the number of first batteries 100_1 to 100_N included in the first battery group 100 and the number of second batteries 200_1 to 200_N included in the second battery group 200. Specifically, the sixth current may be calculated by Equation 1 described above.

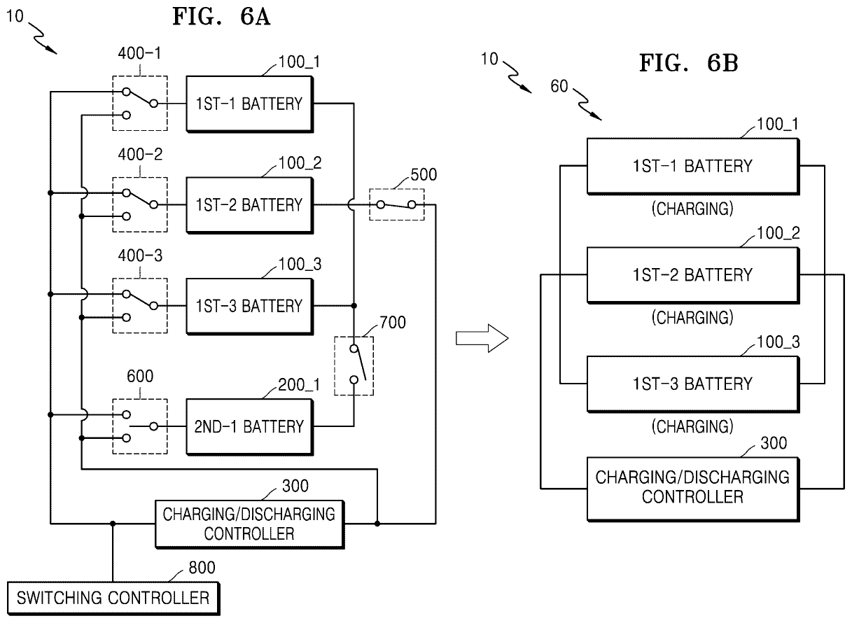

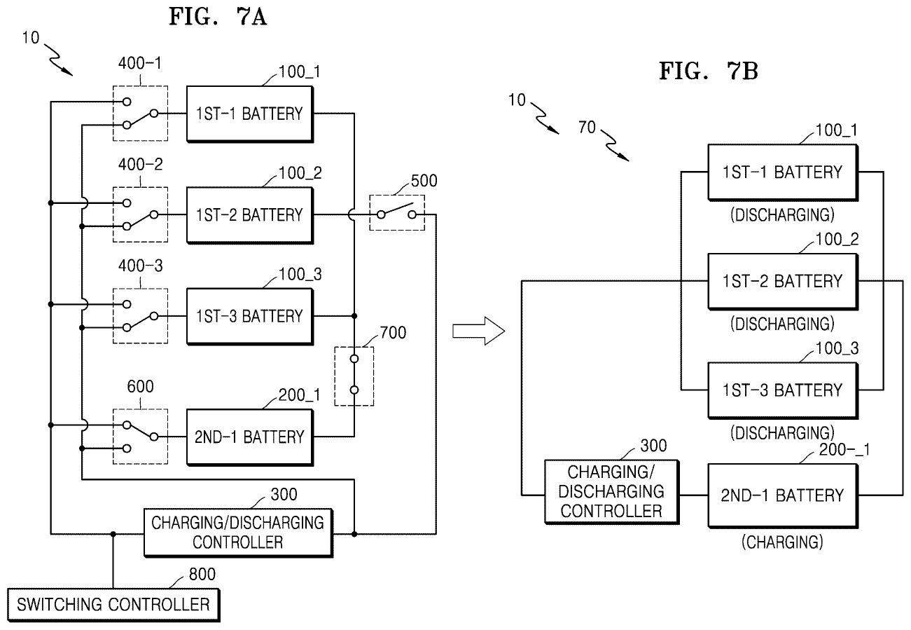

FIGS. 6A and 6B, 7A and 7B illustrate exemplary configurations of a battery charging/discharging control system 10 according to some embodiments, and FIG. 8A through 8D illustrate pulse timing diagrams corresponding to first and second pulses used in a battery charging/discharging control system 10 according to some embodiments. In the following description, parts redundant to the descriptions of FIGS. 1 to 5 are omitted. Referring to FIGS. 6 to 8D, a battery charging/discharging control system 10 may include the first battery group 100, the second battery group 200, the charging/discharging controller 300, the first switching unit 400, the second switching unit 500, the third switching unit 600, the fourth switching unit 700, and the switching controller 800. The first battery group 100 may include a 1st-1 battery 100_1, a 1st-2 battery 100_2, and a 1st-3 battery 100_3 that are connected in parallel with one another. The second battery group 200 may include a 2nd-1 battery 200_1. The 2nd-1 battery 200_1 may be connected in parallel to the 1st-1 battery 100_1, the 1st-2 battery 100_2, and the 1st-3 battery 100_3.

The charging/discharging controller 300 may generate the first pulse and the second pulse different from the first pulse. The charging/discharging controller 300 may supply the first pulse and the second pulse to the 1st-1 battery 100_1, the 1st-2 battery 100_2, the 1st-3 battery 100_3, and the 2nd-1 battery 200_1.

The charging/discharging controller 300 may control the charging/discharging of the 1st-1 battery 100_1, the 1st-2 battery 100_2, and the 1st-3 battery 100_3 by supplying the first pulse to the 1st-1 battery 100_1, the 1st-2 battery 100_2, and the 1st-3 battery 100_3. The charging/discharging controller 300 may control the charging of the 2nd-1 battery 200_1 by supplying the second pulse to the 2nd-1 battery 200_1.

The charging/discharging controller 300 may control the 2nd-1 battery 200_1 to enter the deactivated state during the charging of the 1st-1 battery 100_1, the 1st-2 battery 100_2, and the 1st-3 battery 100_3. The charging/discharging controller 300 may control the 2nd-1 battery 200_1 to be charged during the discharging of the 1st-1 battery 100_1, the 1st-2 battery 100_2, and the 1st-3 battery 100_3.

The first switching unit 400 may include a 1st-1 switching unit 400_1, a 1st-2 switching unit 400_2, and a 1st-3 switching unit 400_3. According to an exemplary embodiment, the first switching unit 400 and the third switching unit 600 may be configured as switching elements having three ends. According to an exemplary embodiment, the second switching unit 500 and the fourth switching unit 700 may be configured as switching elements having two ends.

The 1st-1 switching unit 400_1 may have a first end connected to a first end of the charging/discharging controller 300, a second end connected to a second end of the charging/discharging controller 300, and a third end connected to a first end of the 1st-1 battery 100_1.

The 1st-2 switching unit 400_2 may have a first end connected to the first end of the charging/discharging controller 300, a second end connected to the second end of the charging/discharging controller 300, and a third end connected to a first end of the 1st-2 battery 100_2.

The 1st-3 switching unit 400_3 may have a first end connected to the first end of the charging/discharging controller 300, a second end connected to the second end of the charging/discharging controller 300, and a third end connected to a first end of the 1st-3 battery 100_3.

The second switching unit 500 may have a first end connected to one of the second ends of the 1st-1 battery 100_1, the 1st-2 battery 100_2, and the 1st-3 battery 100_3 connected in parallel, and a second end connected to the second end of the charging/discharging controller 300.

The third switching unit 600 may have a first end connected to the first end of the charging/discharging controller 300, a second end connected to the second end of the charging/discharging controller 300, and a third end connected to the first end of the 2nd-1 battery 200_1.

The fourth switching unit 700 may have a first end connected to one of the second ends of the 1st-1 battery 100_1, the 1st-2 battery 100_2, and the 1st-3 battery 100_3 connected in parallel, and a second end connected to the second end of the 2nd-1 battery 200_1. The switching controller 800 may control the switching on or off of the first switching unit 400 to the fourth switching unit 700 to form the first closed loop 20 during the charging of the 1st-1 battery 100_1, the 1st-2 battery 100_2, and the 1st-3 battery 100_3 by the first pulse (FIG. 8A).

Specifically, the switching controller 800 may control the first closed loop 20 to be formed by outputting the first switching control signal for switching on the first switching unit 400 and the second switching unit 500 and switching off the third switching unit 600 and the fourth switching unit 700 during the charging of the 1st-1 battery 100_1, the 1st-2 battery 100_2, and the 1st-3 battery 100_3.

FIG. 6A shows an example in which the first switching unit 400 and the second switching unit 500 are switched on and the third switching unit 600 and the fourth switching unit 700 are switched off by the first switching control signal. FIG. 6B shows the first closed loop 60 resulting from the first switching control signal. The 1st-1 battery 100_1, the 1st-2 battery 100_2, the 1st-3 battery 100_3, and the charging/discharging controller 300 form the first closed loop 60 as shown.

As the battery charging/discharging control system 10 forms the first closed loop 60, the 1st-1 battery 100_1, the 1st-2 battery 100_2, and the 1st-3 battery 100_3 may be charged, and the 2nd-1 battery 200_1 may enter the deactivated state. According to an exemplary embodiment, the switching controller 800 may output the first switching control signal during a first time period included in a cycle of the first pulse.

The switching controller 800 may control the switching on or off of the first switching unit 400 to the fourth switching unit 700 to form a second closed loop 70 during the discharging of the 1st-1 battery 100_1, the 1st-2 battery 100_2, and the 1st-3 battery 100_3 by the first pulse.

Specifically, the switching controller 800 may control the second closed loop 70 to be formed by outputting the second switching control signal for switching on the first switching unit 400, the third switching unit 600, and the fourth switching unit 700 and switching off the second switching unit 500 during the discharging of the 1st-1 battery 100_1, the 1st-2 battery 100_2, and the 1st-3 battery 100_3.

FIG. 7A shows an example in which the first switching unit 400, the third switching unit 600, and the fourth switching unit 700 are switched on and the second switching unit 500 is switched off by the second switching control signal. FIG. 7B shows the second closed loop 70 resulting from the second switching control signal. The 1st-1 battery 100_1, the 1st-2 battery 100_2, the 1st-3 battery 100_3, the 2nd-1 battery 200_1, and the charging/discharging controller 300 form the second closed loop 70 as shown.

As the battery charging/discharging control system forms the second closed loop 75, the 1st-1 battery 100_1, the 1st-2 battery 100_2, and the 1st-3 battery 100_3 may be discharged, and the 2nd-1 battery 200_1 may be charged. According to some embodiments, the switching controller 800 may output the second switching control signal during a third time period included in a cycle of the first pulse.

Meanwhile, the charging/discharging controller 300 may control charging/discharging by generating the first pulse and the second pulse, supplying the first pulse to the 1st-1 battery 100_1, the 1st-2 battery 100_2, and the 1st-3 battery 100_3, and supplying the second pulse to the 2nd-1 battery 200_1.

FIG. 8A shows one cycle of the first pulse, and FIG. 8C shows multiple cycles of the first pulse. In one cycle of the first pulse shown in FIG. 8A, the first current (e.g., 3 A) may be set during the first time period (e.g., 0-15 seconds(s), 15 second duration), the second current (e.g., 0 A) that is less than the first current may be set during the second time period (e.g., 15-20 s, 5 second duration) that is shorter than a duration of the first time period, the third current (e.g., −3 A) may be set as a reverse current corresponding to the first current during the third time period (e.g., 20-25 s, 5 second duration) that is the same duration as the second time period, and the fourth current (e.g., 0 A) may be set as a current equal to the second current during the fourth time duration (e.g., 25-30 s, 5 second duration) that is the same duration as the second time period.

From FIG. 8A, the 1st-1 battery 100_1, the 1st-2 battery 100_2, and the 1st-3 battery 100_3 may be charged by the first current during the first time period included in one cycle of the first pulse, the 1st-1 battery 100_1, the 1st-2 battery 100_2, and the 1st-3 battery 100_3 may be reset by the second current during the second time period, the 1st-1 battery 100_1, the 1st-2 battery 100_2, and the 1st-3 battery 100_3 may be discharged by the third current during the third time period, and the 1st-1 battery 100_1, the 1st-2 battery 100_2, and the 1st-3 battery 100_3 may be reset by the fourth current during the fourth time period.

FIG. 8B shows one cycle of the second pulse, and FIG. 8D shows multiple cycles of the second pulse. In one cycle of the second pulse shown in FIG. 8B, the fifth current (e.g., 0 A) may be set during the first time period and the second time period, the sixth current (e.g., 8 A) may be set during the third time period, and the seventh current (e.g., 0 A) may be set to be the same current as the fifth current during the fourth time period.

From FIG. 8B, the 2nd-1 battery 200_1 may be in the deactivated state during the first time period, the second time period, and the fourth time period included in one cycle of the second pulse. From FIG. 8B, the 2nd-1 battery 200_1 may be charged by the sixth current during the third time period included in one cycle of the second pulse. According to some embodiments, the sixth current may be calculated as 9 A (3×3/1) based on Equation 1 described above.

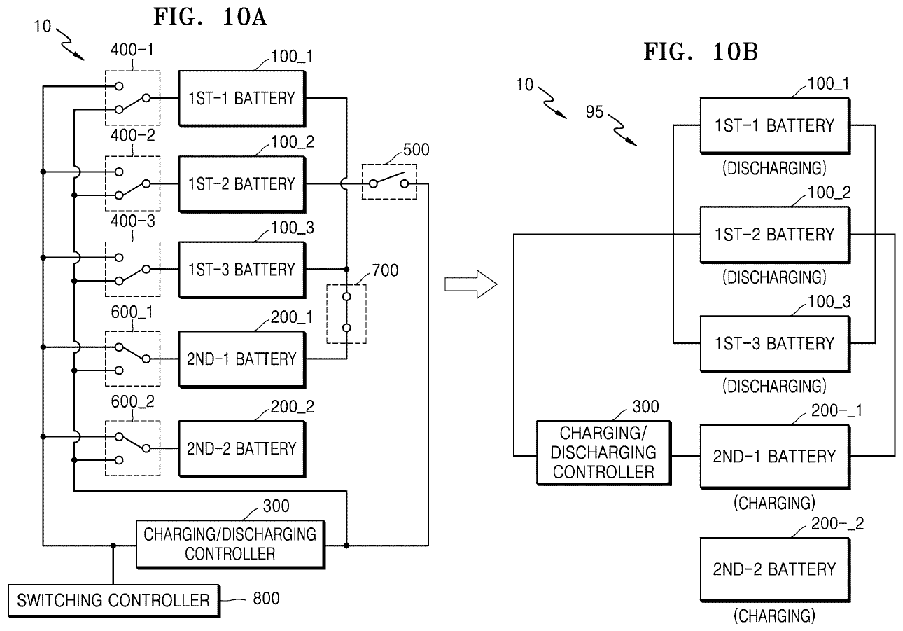

FIGS. 9A and 9B, 10A and 10B illustrate exemplary configurations of a battery charging/discharging control system 10 according to some embodiments. FIG. 11A through 11D are pulse timing diagrams of the first pulse and the second pulse used in a battery charging/discharging control system 10 according to some embodiments. In the following description, parts redundant to the descriptions of FIGS. 1 to 8D are omitted. Referring to FIGS. 9 to 11D, a battery charging/discharging control system 10 according to an exemplary embodiment may include the first battery group 100, the second battery group 200, the charging/discharging controller 300, the first switching unit 400, the second switching unit 500, the third switching unit 600, the fourth switching unit 700, and the switching controller 800.

The first battery group 100 may include the 1st-1 battery 100_1, the 1st-2 battery 100_2, and the 1st-3 battery 100_3 that are connected in parallel with one another. The second battery group 200 may include the 2nd-1 battery 200_1 and a 2nd-2 battery 200_2. The 2nd-1 battery 200_1 and the 2nd-2 battery 200_2 may be connected in parallel to the 1st-1 battery 100_1, the 1st-2 battery 100_2, and the 1st-3 battery 100_3.

The charging/discharging controller 300 may generate the first pulse and the second pulse different from the first pulse. The charging/discharging controller 300 may supply the first pulse and the second pulse to the 1st-1 battery 100_1, the 1st-2 battery 100_2, the 1st-3 battery 100_3, the 2nd-1 battery 200_1, and the 2nd-2 battery 200_2.

The charging/discharging controller 300 may control the charging/discharging of the 1st-1 battery 100_1, the 1st-2 battery 100_2, and the 1st-3 battery 100_3 by supplying the first pulse to the 1st-1 battery 100_1, the 1st-2 battery 100_2, and the 1st-3 battery 100_3.

The charging/discharging controller 300 may control the charging of the 2nd-1 battery 200_1 by supplying the second pulse to the 2nd-1 battery 200_1 and the 2nd-2 battery 200_2.

The charging/discharging controller 300 may control the 2nd-1 battery 200_1 and the 2nd-2 battery 200_2 to enter the deactivated state during the charging of the 1st-1 battery 100_1, the 1st-2 battery 100_2, and the 1st-3 battery 100_3. The charging/discharging controller 300 may control the 2nd-1 battery 200_1 and the 2nd-2 battery 200_2 to be charged during the discharging of the 1st-1 battery 100_1, the 1st-2 battery 100_2, and the 1st-3 battery 100_3.

The first switching unit 400 may include the 1st-1 switching unit 400_1, the 1st-2 switching unit 400_2, and the 1st-3 switching unit 400_3. The third switching unit 600 may include a 3rd-1 switching unit 600_1 and a 3rd-2 switching unit 600_2.

According to exemplary embodiments, the first switching unit 400 and the third switching unit 600 may be configured as switching elements having three ends. According to exemplary embodiments, the second switching unit 500 and the fourth switching unit 700 may be configured as switching elements having two ends.

The 1st-1 switching unit 400_1 may have the first end connected to the first end of the charging/discharging controller 300, the second end connected to the second end of the charging/discharging controller 300, and the third end connected to the first end of the 1st-1 battery 100_1.

The 1st-2 switching unit 400_2 may have the first end connected to the first end of the charging/discharging controller 300, the second end connected to the second end of the charging/discharging controller 300, and the third end connected to the first end of the 1 st-2 battery 100_2.

The 1st-3 switching unit 400_3 may have the first end connected to the first end of the charging/discharging controller 300, the second end connected to the second end of the charging/discharging controller 300, and the third end connected to the first end of the 1st-3 battery 100_3.

The second switching unit 500 may have the first end connected to one of the second ends of the 1st-1 battery 100_1, the 1st-2 battery 100_2, and the 1st-3 battery 100_3 connected in parallel, and the second end connected to the second end of the charging/discharging controller 300.

The 3rd-1 switching unit 600_1 may have the first end connected to the first end of the charging/discharging controller 300, the second end connected to the second end of the charging/discharging controller 300, and the third end connected to the first end of the 2nd-1 battery 200_1.

The 3rd-2 switching unit 600_2 may have the first end connected to the first end of the charging/discharging controller 300, the second end connected to the second end of the charging/discharging controller 300, and the third end connected to the first end of the 2nd-2 battery 200_2.

The fourth switching unit 700 may have a first end connected to one of the second ends of the 1st-1 battery 100_1, the 1st-2 battery 100_2, and the 1st-3 battery 100_3 connected in parallel, and a second end connected to the second end of one of the 2nd-1 battery 200_1 and the 2nd-2 battery 200_2 that are connected in parallel with each other.

The switching controller 800 may control the switching on or off of the first switching unit 400 to the fourth switching unit 700 to form the first closed loop 90 during the charging of the 1st-1 battery 100_1, the 1st-2 battery 100_2, and the 1st-3 battery 100_3 by the first pulse (FIG. 11A).

Specifically, the switching controller 800 may control the first closed loop 90 to be formed by outputting the first switching control signal for switching on the first switching unit 400 and the second switching unit 500 and switching off the third switching unit 600 and the fourth switching unit 700 during the charging of the 1st-1 battery 100_1, the 1st-2 battery 100_2, and the 1st-3 battery 100_3.

FIG. 9A shows an example in which the first switching unit 400 and the second switching unit 500 are switched on and the third switching unit 600 and the fourth switching unit 700 are switched off by the first switching control signal. FIG. 9B shows the first closed loop 90 resulting from the first switching control signal. The 1st-1 battery 100_1, the 1st-2 battery 100_2, the 1st-3 battery 100_3, and the charging/discharging controller 300 form the first closed loop 90 as shown.

As the battery charging/discharging control system forms the first closed loop 90, the 1st-1 battery 100_1, the 1st-2 battery 100_2, and the 1st-3 battery 100_3 may be charged, and the 2nd-1 battery 200_1 may enter the deactivated state. According to some embodiments, the switching controller 800 may output the first switching control signal during the first time period included in the first pulse.

The switching controller 800 may control the switching on or off of the first switching unit 400 to the fourth switching unit 700 to form a second closed loop 95 during the discharging of the 1st-1 battery 100_1, the 1st-2 battery 100_2, and the 1st-3 battery 100_3 by the first pulse.

Specifically, the switching controller 800 may control the second closed loop 95 to be formed by outputting the second switching control signal for switching on the first switching unit 400, the second switching unit 600, and the fourth switching unit 700 and turning off the second switching unit 500 during the discharging of the 1st-1 battery 100_1, the 1st-2 battery 100_2, and the 1st-3 battery 100_3.

FIG. 10A shows an example in which the first switching unit 400, the third switching unit 600, and the fourth switching unit 700 are switched on and the second switching unit 500 is switched off by the second switching control signal. FIG. 10B shows the resulting second closed loop 95. The 1st-1 battery 100_1, the 1st-2 battery 100_2, the 1st-3 battery 100_3, the 2nd-1 battery 200_1, the 2nd-2 battery 200_2, and the charging/discharging controller 300 form the second closed loop 95 as shown.

As the battery charging/discharging control system 10 forms the second closed loop 95, the 1st-1 battery 100_1, the 1st-2 battery 100_2, and the 1st-3 battery 100_3 may be discharged, and the 2nd-1 battery 200_1 and the 2nd-2 battery 200_2 may be charged. According to some embodiments, the switching controller 800 may output the second switching control signal during a third time period included in the first pulse.

The charging/discharging controller 300 may control charging/discharging by generating the first pulse and the second pulse, supplying the first pulse to the 1st-1 battery 100_1, the 1st-2 battery 100_2, and the 1st-3 battery 100_3, and supplying the second pulse to the 2nd-1 battery 200_1 and the 2nd-2 battery 200_2.

FIG. 11A shows one cycle of the first pulse, and FIG. 11C shows multiple cycles of the first pulse. In one cycle of the first pulse, shown in FIG. 11A, the first current (e.g., 4 A) may be set during the first time period (e.g., 0-15 s, 15 second duration), the second current (e.g., 0 A) that is less than the first current may be set during the second time period (e.g., 15-21 s, 6 second duration) that is shorter than a duration of the first time period, the third current (e.g., −4 A) may be set as a reverse current corresponding to the first current during the third time period (e.g., 21-27 s) that is the same duration as the second time period, and the fourth current may be set as a current equal to the second current during the fourth time period (e.g., 27-33 s) that is the same duration as the second time period.

From FIG. 11A, the 1st-1 battery 100_1, the 1st-2 battery 100_2, and the 1st-3 battery 100_3 may be charged by the first current during the first time period included in one cycle of the first pulse, the 1st-1 battery 100_1, the 1st-2 battery 100_2, and the 1st-3 battery 100_3 may be reset by the second current during the second time period, the 1st-1 battery 100_1, the 1st-2 battery 100_2, and the 1st-3 battery 100_3 may be discharged by the third current during the third time period, and the 1st-1 battery 100_1, the 1st-2 battery 100_2, and the 1st-3 battery 100_3 may be reset by the fourth current during the fourth time period.

FIG. 11B shows one cycle of the second pulse, and FIG. 11D shows multiple cycles of the second pulse. In one cycle of the second pulse shown in FIG. 11B, the fifth current (e.g., 0 A) may be set during the first time and the second time periods, the sixth current may be set during the third time period, and the seventh current may be set to be the same current as the fifth current during the fourth time period.

From FIG. 11B, the 2nd-1 battery 200_1 and the 2nd-2 battery 200_2 may be in the deactivated state during the first time period, the second time period, and the fourth time period included in one cycle of the second pulse. From FIG. 11B, the 2nd-1 battery 200_1 and the 2nd-2 battery 200_2 may be charged by the sixth current during the third time period included in one cycle of the second pulse. According to some embodiments, the sixth current may be calculated as 6 A (4×3/2) based on Equation 1 described above. While the present disclosure is described with reference to embodiments and drawings illustrating aspects thereof, the present disclosure is not limited thereby and various modifications and changes may be made by those of ordinary skill in the art to which the present disclosure belongs within the scope of the technical spirit of the present disclosure and the claims and their equivalents below.

According to some embodiments, by charging several batteries at the same time by supplying current to one battery group using reverse current generated while pulse-charging another battery group, charging efficiency may be increased.

In addition, by simultaneously charging several batteries by supplying current to one battery group using the reverse current generated while pulse-charging another battery group, charging imbalance between batteries may be reduced and power consumption may be efficiently managed.

Furthermore, by charging several batteries at the same time by supplying current to one battery group using reverse current generated while pulse-charging another battery group, a total charging time may be shortened.

However, effects that may be obtained through the present disclosure are not limited to the above-described effects, and other technical effects not mentioned may be clearly understood by those of ordinary skill in the art from the description of the present disclosure described below.

What is claimed is:

1. A battery charging/discharging control system comprising:
a first battery group comprising one or more first batteries connected in parallel;
a second battery group connected in parallel with the first battery group and comprising one or more second batteries connected in parallel; and
a charging/discharging controller configured to generate a first current pulse and a second current pulse, different from the first current pulse, and to supply the first current pulse and the second current pulse to the first battery group and the second battery group to control charging/discharging.

2. The battery charging/discharging control system of claim 1, wherein the charging/discharging controller is further configured to:
control the charging/discharging of the first battery group by supplying the first current pulse to the first battery group; and
control the charging of the second battery group by supplying the second current pulse to the second battery group.

3. The battery charging/discharging control system of claim 1, wherein the charging/discharging controller is further configured to control the second battery group to enter a deactivated state during the charging of the first battery group.

4. The battery charging/discharging control system of claim 1, wherein the charging/discharging controller is further configured to control the second battery group to be charged during the discharging of the first battery group.

5. The battery charging/discharging control system of claim 1, further comprising:
each of a plurality of switching units configured to be turned on or off such that the first battery group and the charging/discharging controller form a first closed loop according to a first configuration of the plurality of the switching units and the first battery group, the second battery group, and the charging/discharging controller form a second closed loop according to a second configuration of the plurality of switching units; and
a switching controller configured to control the plurality of switching units to form the first configuration or the second configuration.

6. The battery charging/discharging control system of claim 5, wherein the switching controller is further configured to:
control the plurality of switching units such that the first closed loop is formed during the charging of the first battery group; and
control the plurality of switching units such that the second closed loop is formed during the discharging of the first battery group.

7. The battery charging/discharging control system of claim 5, wherein the switching controller is included in the charging/discharging controller.

8. The battery charging/discharging control system of claim 5, wherein the plurality of switching units comprise:
a first switching unit comprising a first end connected to a first end of the charging/discharging controller and a second end connected to a first end of the first battery group;
a second switching unit comprising a first end connected to a second end of the first battery group and a second end connected to a second end of the charging/discharging controller;
a third switching unit comprising a first end connected to the second end of the first battery group and a second end connected to a first end of the second battery group; and
a fourth switching unit comprising a first end connected to a second end of the second battery group and a second end connected to the second end of the charging/discharging controller.

9. The battery charging/discharging control system of claim 8, wherein the switching controller is further configured to:
control the first closed loop to be formed, by outputting the first switching control signal for switching on the first switching unit and the second switching unit and switching off the third switching unit and the fourth switching unit during the charging of the first battery group; and
control the second closed loop to be formed, by outputting the second switching control signal for switching on the first switching unit to the fourth switching unit during the discharging of the first battery group.

10. The battery charging/discharging control system of claim 1, wherein the charging/discharging controller is further configured to:
generate the first current pulse in which a first current is set during a first time period, a second current, less than the first current, is set during a second time period shorter than a duration of the first time, a third current is set as a reverse current corresponding to the first current during a third time period that is a same duration as the second time period, and a fourth current is set as a current equal to the second current during a fourth time period that is a same duration as the second time period; and
generate the second current pulse in which a fifth current is set during the first time period and the second time period, a sixth current is set during the third time period, and a seventh current is set to be the same as the fifth current during the fourth time period.

11. The battery charging/discharging control system of claim 10, wherein the charging/discharging controller is further configured to control the first battery group to be charged by the first current and the first battery group to be discharged by the third current, wherein the first current and the third current are included in the first current pulse, and the second battery group to be charged by the sixth current included in the second current pulse.

12. The battery charging/discharging control system of claim 10, wherein the sixth current is adjusted according to a number of first batteries included in the first battery group and a number of second batteries included in the second battery group.

13. A battery charging/discharging control method performed by a processor of a charging/discharging controller configured to control charging/discharging of a first battery group comprising one or more first batteries connected in parallel and a second battery group comprising one or more second batteries connected in parallel with the first battery group, the battery charging/discharging control method comprising:
generating a first current pulse and a second current pulse different from the first current pulse; and
controlling charging/discharging by supplying the first current pulse and the second current pulse to the first battery group and the second battery group.

14. The battery charging/discharging control method of claim 13, wherein the controlling of the charging/discharging comprises:
controlling the charging/discharging of the first battery group by supplying the first current pulse to the first battery group; and
controlling the charging of the second battery group by supplying the second current pulse to the second battery group.

15. The battery charging/discharging control method of claim 13, wherein the controlling of the charging/discharging comprises controlling the second battery group to enter a deactivated state during the charging of the first battery group.

16. The battery charging/discharging control method of claim 13, wherein the controlling of the charging/discharging comprises controlling the second battery group to be charged during the discharging of the first battery group.

17. The battery charging/discharging control method of claim 13, wherein the generating comprises:
generating the first current pulse in which, for each cycle, a first current is set during a first time period, a second current, less than the first current, is set during a second time period shorter than a duration of the first time period, a third current is set as a reverse current corresponding to the first current during a third time period that is a same duration as the second time period, and a fourth current is set as a current equal to the second current during a fourth time period that is a same duration as the second time period; and
generating a second current pulse in which, for each cycle, a fifth current is set during the first time period and the second time period, a sixth current is set during the third time period, and a seventh current is set to be the same as the fifth current during the fourth time period.

18. The battery charging/discharging control method of claim 17, wherein the controlling of the charging/discharging comprises controlling the first battery group to be charged by the first current and the first battery group to be discharged by the third current, wherein the first current and the third current are included in the first current pulse, and the second battery group to be charged by the sixth current included in the second current pulse.

19. The battery charging/discharging control method of claim 17, wherein the sixth current is adjusted according to a number of first batteries included in the first battery group and a number of second batteries included in the second battery group.

20. A non-transitory computer-readable recording medium having stored thereon a computer program for causing a computer to execute the battery charging/discharging control method of claim 13.
